(19) United States
(12) Patent Application Publication
(10) Pub. No.: US 2011/0055031 A1
(43) Pub. Date: Mar. 3, 2011

(54) REGISTRATION TERMINAL, SETTLEMENT TERMINAL, TRANSACTION CONTENT CHANGING METHOD, AND COMMODITY SALES PROCESSING APPARATUS

(75) Inventor: Hiroshi Takagi, Shizuoka (JP)

(73) Assignee: TOSHIBA TEC KABUSHIKI KAISHA, Tokyo (JP)

(21) Appl. No.: 12/873,571

(22) Filed: Sep. 1, 2010

(30) Foreign Application Priority Data
Sep. 3, 2009 (JP) 2009-204031

(51) Int. Cl. G06Q 30/00

(52) U.S. Cl. 705/16

(57) ABSTRACT

According to one embodiment, a registration terminal includes: a connecting unit connected to a settlement terminal, the settlement terminal being configured to store sales data indicating transaction content of a transaction for purchase of a commodity transmitted from the outside and execute processing concerning settlement of the transaction on the basis of the stored sales data; a generating unit configured to generate, every time the transaction is performed, sales data indicating content of the transaction; a registering unit configured to transmit the sales data generated by the generating unit to the settlement terminal; a readout requesting unit configured to request the settlement terminal to read out the sales data stored in the settlement terminal; and a changing unit configured to change the transaction content of the sales data read out from the settlement terminal and transmit the sales data after the change to the settlement terminal as sales data for update.

### CROSS-REFERENCE TO RELATED APPLICATION

This application claims the benefit of priority from Japanese Patent Application No. 2009-204031 filed Sep. 3, 2009, the entire content of which are incorporated herein by reference.

### FIELD

Embodiments described herein relate generally to a registration terminal, a settlement terminal, a transaction content changing method, and a commodity sales processing apparatus.

### BACKGROUND

In the past, in a retail store such as a supermarket, a commodity sales processing apparatus called two-person type is used in which reading of a commodity code attached to a commodity and settlement of the commodity are divided between two operators. Such a commodity sales processing apparatus includes a registration terminal configured to generate sales data indicating transaction contents of transactions and a settlement terminal configured to perform settlement of the transactions on the basis of the sales data. The two operators can divide roles and proceed with processing by respectively operating the terminals.

In the two-person type commodity sales processing apparatus in the past, after sales data is passed from the registration terminal to the settlement terminal for one transaction, transaction content of the sales data cannot be changed in the registration terminal. Therefore, for example, when addition or deletion of a commodity is performed during settlement or in a state of wait for settlement, the settlement terminal needs to cope with the addition or the deletion. This complicates operation for the change. To solve this problem, JP-A-2000-48260 discloses a technique for, when cancellation or additional purchase of a commodity is instructed concerning a transaction being settled, generating, in the registration terminal, correction information (a commodity code) corresponding to content of the instruction and notifying the settlement terminal of the correction information to correct sales data.

However, in the technique disclosed in JP-A-2000-48260, processing can be performed for only the transaction being settled. Therefore, when a change occurs in the transaction in a state of wait for settlement, it is impossible to immediately cope with the change and efficiently process a change of sales data.

### BRIEF DESCRIPTION OF THE DRAWINGS

FIG. 1 is a schematic perspective view of an example of the external configuration of a commodity sales processing apparatus;

FIG. 2 is a block diagram of an example of a control configuration of the commodity sales processing apparatus shown in FIG. 1;

FIG. 3 is a diagram of an example of data items included in a PLU table shown in FIG. 2;

FIG. 4 is a diagram of an example of a transaction selection screen displayed on a display device of a registration terminal;

FIG. 5 is a diagram of an example of data items included in a settlement table shown in FIG. 2;

FIG. 6 is a diagram of an example of a settlement screen displayed on a display device of a settlement terminal;

FIG. 7 is a diagram of an example of a settlement screen displayed on the display device of the settlement terminal; and

FIG. 8 is a flowchart for explaining a procedure of sales data changing processing executed in the commodity sales processing apparatus shown in FIG. 1.

### DETAILED DESCRIPTION

In general, according to one embodiment, a registration terminal includes: a connecting unit connected to a settlement terminal, the settlement terminal being configured to store sales data indicating transaction content of a transaction for purchase of a commodity transmitted from the outside and execute processing concerning settlement of the transaction on the basis of the stored sales data; a generating unit configured to generate, every time the transaction is performed, sales data indicating content of the transaction; a registering unit configured to transmit the sales data generated by the generating unit to the settlement terminal; a readout requesting unit configured to request the settlement terminal to read out the sales data stored in the settlement terminal; and a changing unit configured to change the transaction content of the sales data read out from the settlement terminal and transmit the sales data after the change to the settlement terminal as sales data for update.

According to another embodiment, a transaction content changing method is a transaction content changing method executed in a registration terminal connected to a settlement terminal, the settlement terminal being configured to store sales data indicating transaction content of a transaction for purchase of a commodity transmitted from the outside and execute processing concerning settlement of the transaction on the basis of the stored sales data. The transaction content changing method includes: allowing a generating unit to generate, every time the transaction is performed, sales data indicating content of the transaction; allowing a registering unit to transmit the sales data generated by the generating unit to the settlement terminal; allowing a readout requesting unit to request the settlement terminal to read out the sales data stored in the settlement terminal; and allowing a changing unit to change the transaction content of the sales data read out from the settlement terminal and transmit the sales data after the change to the settlement terminal as sales data for update.

According to another embodiment, a settlement terminal includes: a connecting unit connected to a registration terminal configured to generate, every time a transaction for purchase of a commodity is performed, sales data indicating content of the transaction; a storing unit configured to store the sales data transmitted from the registration terminal; a readout unit configured to read out, according to a readout request from the registration terminal, the sales data stored in the storing unit and transmit the sales data to the registration terminal; and an updating unit configured to update, on the basis of sales data for update, in which the transaction content is changed, transmitted from the registration terminal, the sales data stored in the storing unit corresponding to the sales data for update.

According to another embodiment, a transaction content changing method is a transaction content changing method executed in a settlement terminal connected to a registration terminal configured to generate, every time a transaction for purchase of a commodity is performed, sales data indicating content of the transaction. The transaction content changing method includes: allowing a storage control unit to store the sales data transmitted from the registration terminal in a storing unit; allowing a readout unit to read out, according to a readout request from the registration terminal, the sales data stored in the storing unit and transmit the sales data to the registration terminal; and allowing an updating unit to update, on the basis of sales data for update, in which the transaction content is changed, transmitted from the registration terminal, the sales data stored in the storing unit corresponding to the sales data for update.

According to another embodiment, a commodity sales processing apparatus is a two-person type commodity sales processing apparatus including a registration terminal and a settlement terminal. The registration terminal includes: a generating unit configured to generate, every time a transaction for purchase of a commodity is performed, sales data indicating content of the transaction; a registering unit configured to transmit the sales data generated by the generating unit to the settlement terminal; a readout requesting unit configured to request the settlement terminal to read out the sales data stored in the settlement terminal; and a changing unit configured to change the transaction content of the sales data read out from the settlement terminal and transmit the sales data after the change to the settlement terminal as sales data for update. The settlement terminal includes: a storing unit configured to store the sales data transmitted from the registration terminal; a readout unit configured to read out, according to a readout request from the registration terminal, the sales data stored in the storing unit and transmit the sales data to the registration terminal; and an updating unit configured to update, on the basis of the sales data for update transmitted from the registration terminal, the sales data stored in the storing unit corresponding to the sales data for update.

Embodiments are explained below with reference to the accompanying drawings. The present invention is not limited by the embodiments explained below.

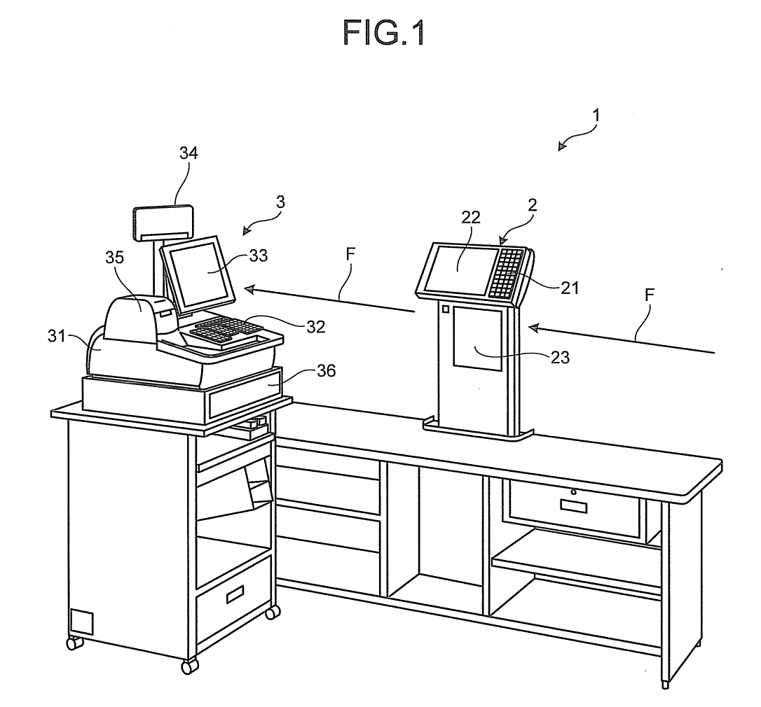

FIG. 1 is a schematic perspective view of an example of the external configuration of a commodity sales processing apparatus 1 according to an embodiment.

The commodity sales processing apparatus 1 is a two-person type commodity sales processing apparatus in which reading of a commodity code attached to a commodity and settlement of the commodity are divided between two operators. As shown in the figure, the commodity sales processing apparatus 1 includes a registration terminal 2 and a settlement terminal 3. The registration terminal 2 is an apparatus operated by a checker. The registration terminal 2 generates, every time a transaction for purchase of a commodity is performed, sales data indicating content of the transaction. The settlement terminal 3 is an apparatus operated by a casher. The settlement terminal 3 sequentially registers (stores) the sales data generated by the registration terminal 2 in a settlement table 531 explained later and executes settlement processing for the transaction (the sales data) in order of the storage. The registration terminal 2 is arranged on an entrance side of a flow F of a customer. The settlement terminal 3 is arranged on an exit side of the flow F of the customer.

The registration terminal 2 includes a keyboard 21 operated by the checker, a display device 22 configured to display the commodity code, a commodity unit price, and the like, and a barcode scanner 23 for optically reading a data code such as a barcode or a two-dimensional code attached to a commodity. On the keyboard 21, various keys such as numeric keys for inputting numerical data such as the numbers of sold items of commodities, a total key for calculating a total amount, and a transaction callback key for receiving a request for changing transaction content are arrayed.

On the other hand, on a housing 31 of the settlement terminal 3, a keyboard 32 operated by the casher and a display device 33 for the casher and a display device 34 for the customer configured to display the total amount, a deposit amount, and the like are provided. A printer 35 configured to print a receipt and a journal is provided on the housing 31. A drawer 36 configured to store cash is drawably provided under the housing 31. On the keyboard 32, various keys such as numeric keys and a cash total key for instructing completion of transaction (settlement) are arrayed.

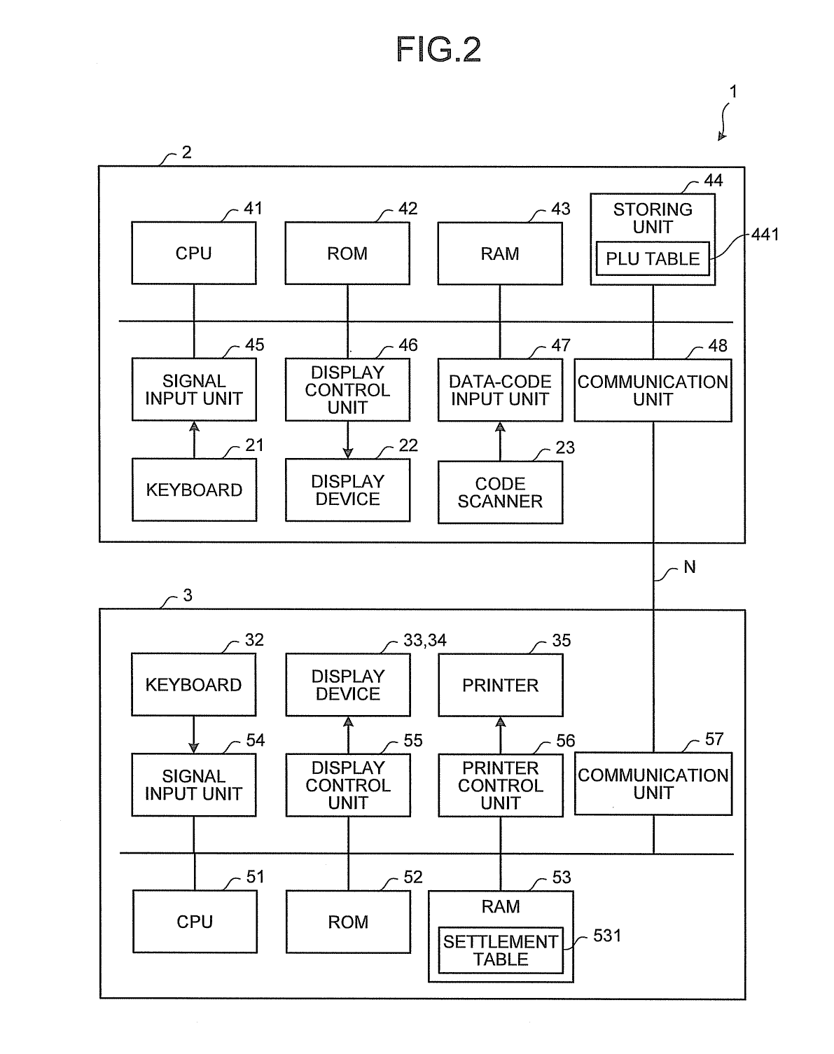

Control configurations of the registration terminal 2 and the settlement terminal 3 are explained with reference to FIG. 2. FIG. 2 is a block diagram of an example of a control configuration of the commodity sales processing apparatus 1.

The registration terminal 2 includes, as shown in FIG. 2, a CPU (Central Processing Unit) 41 configured to perform various kinds of arithmetic processing, a ROM (Read Only Memory) 42 configured to store various control programs executed by the CPU 41, a RAM (Random Access Memory) 43 configured to function as a work area of the CPU 41, a storing unit 44 including a storage device such as a HDD (Hard Disk Drive) or an SSD (Solid State Drive), a signal input unit 45 configured to capture a signal from the keyboard 21, a display control unit 46 configured to output display data to the display device 22, a data-code input unit 47 configured to capture a signal (a data code) from the code scanner 23, and a communication unit 48 connected to the settlement terminal 3 via a transmission line N.

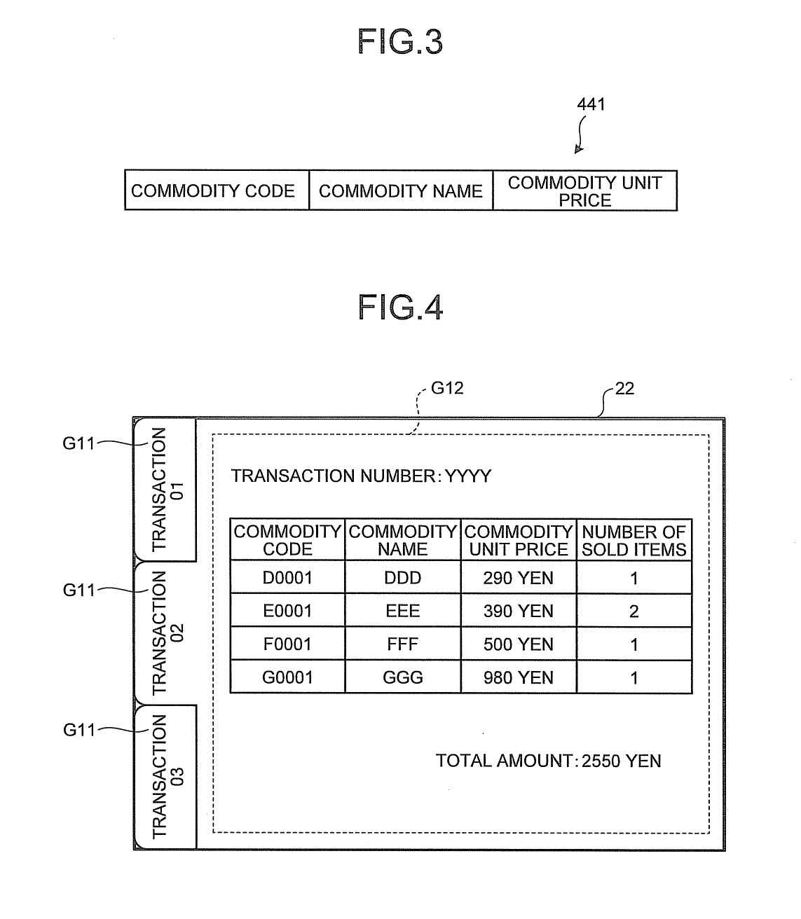

The storing unit 44 stores a PLU (price lookup) table 441 in which, concerning commodities sold in a store, commodity codes, commodity names, commodity unit prices, and the like of the commodities are stored in association with one another. FIG. 3 is a diagram of an example of data items included in the PLU table 441. As shown in FIG. 3, the PLU table 441 includes data items such as a “commodity code”, a “commodity name”, and a “commodity unit price”. The commodity code is a peculiar code set in advance for each commodity in order to identify various commodity items sold in the store. The commodity name and the commodity unit price are information concerning commodities specified by the same commodity code. In this embodiment, the registration terminal 2 incorporates the storing unit 44. However, the present invention is not limited to this. A storage device included in an external apparatus (e.g., a server apparatus) that can communicate with the registration terminal 2 may be the storing unit 44.

The checker who operates the registration terminal 2 holds a data code attached to a commodity over the code scanner 23 to cause the code scanner 23 to read the data code and inputs the number of sold items via the numeric keys to register a commodity set as a purchase target by the customer.

When the code scanner 23 reads the data code, the code scanner 23 outputs the data code to the CPU 41 via the data-code input unit 47. When the CPU 41 receives the data code via the data-code input unit 47, the CPU 41 decodes the data code to acquire a commodity code stored in the data code. The CPU 41 reads out, every time the CPU 41 acquires a commodity code from data code, a commodity name and a commodity unit price corresponding to the commodity code from the PLU table 441 and stores the commodity name and the commodity unit price in a work area of the RAM 43 in association with the number of sold items. When the input of the number of sold items is not explicitly performed, a default value “1” is automatically input.

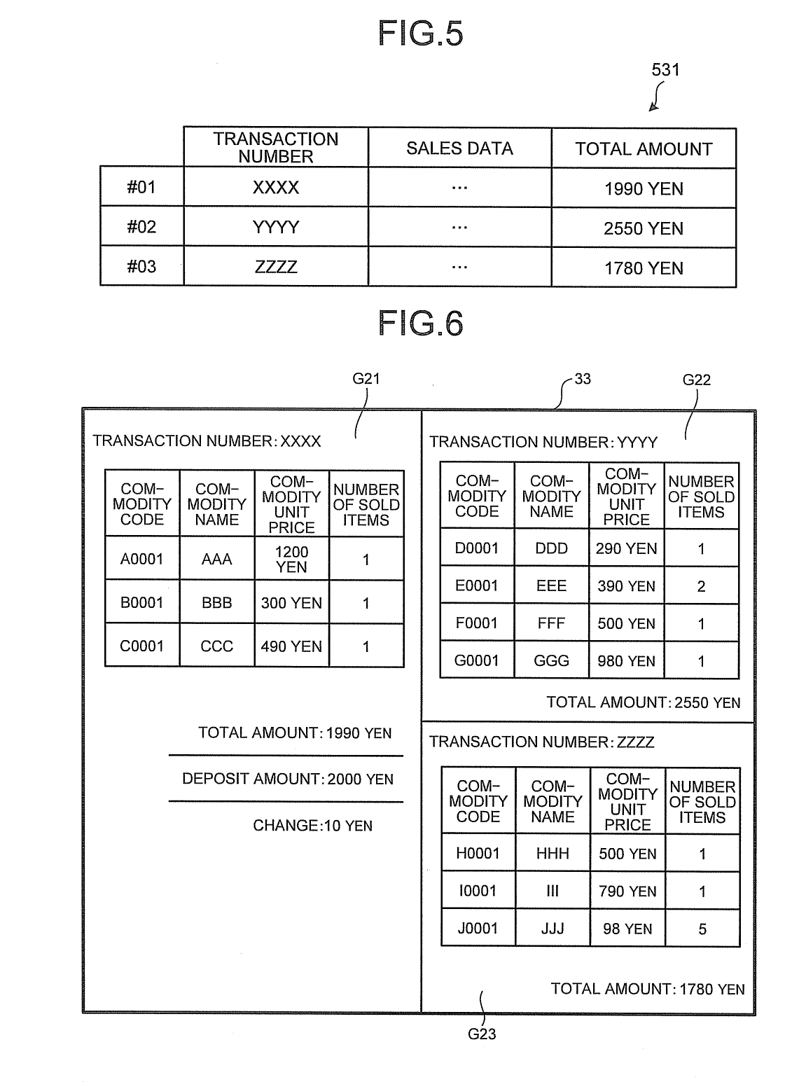

When the CPU 41 detects depression of the total key via the signal input unit 45, the CPU 41 calculates, on the basis of unit prices and the numbers of sold items of commodities stored in the work area, a total amount of the commodities set as purchase targets. The CPU 41 generates, as sales data indicating transaction content of one transaction, sets of commodity codes, commodity names, commodity unit prices, and the numbers of sold items stored in the work area. The CPU transmits the generated sales data to the settlement terminal 3 together with a transaction number for the transaction and the calculated total amount to register these data in the settlement table 531 (see FIGS. 2 and 5) as a record related to the settlement target transaction. The transaction number is identification information for identifying transactions. A peculiar value is given as the transaction number for each transaction. When the CPU 41 completes the registration of the sales data, the CPU 41 deletes the sales data from the work area in preparation for the next transaction.

When the CPU 41 detects depression of the transaction callback key of the keyboard 21 via the signal input unit 45, the CPU 41 starts sales data changing processing for changing sales data related to a transaction being settled or not settled, registered in the settlement terminal 3. In the sales data changing processing, the CPU 41 transmits a record readout request to the settlement terminal 3 to acquire, from the settlement terminal 3, records stored in the settlement table 531 which will be described later, i.e., transaction numbers, sales data, and total amounts concerning registered transactions. Transaction correction processing may be executed at arbitrary timing. However, when the transaction correction processing is executed during the reading of the commodity code, transaction related to the reading of the commodity code is suspended.

When the CPU 41 acquires the record from the settlement terminal 3, the CPU 41 causes the display control unit 46 to display, on the display device 22, a screen for causing the checker to select a transaction to be a target of change (hereinafter referred to as transaction selection screen) on the basis of the information included in the record.

FIG. 4 is a diagram of an example of the transaction selection screen displayed on the display device 22. In the figure, tab images G11 are GUIs for causing the checker to select a transaction to be a target of change and are respectively associated with the records (the transaction numbers), i.e., the transactions acquired from the settlement terminal 3. In FIG. 4, an example in which three records are acquired from the settlement terminal 3 is assumed. Therefore, three tab images G11 respectively corresponding to the records are displayed. The tab images G11 and the records are desirably associated according to order of the records transmitted from the settlement terminal 3. In this case, the tab images G11 and the records of transactions 01 to 03 are associated in order of settlement.

When any one of the tab images G11 is selected via the keyboard 21, the CUP 41 causes the display device 22 to display, in a display area G12, information (a transaction number, sales data, and a total amount) included in the record associated with the tab image G11. In FIG. 4, an example in which the tab image G11 of the “transaction 02” is selected is shown. The checker instructs, on the basis of the transaction content displayed in the display area G12, a change such as cancellation of a purchased commodity or additional purchase of a new commodity via the keyboard 21. The CPU 41 receives, via the signal input unit 45, the instruction for changing the transaction content input via the keyboard 21.

When the CPU 41 receives the instruction for change in a state in which the specific tab image G11 is selected, the CPU 41 changes, according to the instruction for change, the transaction content of the sales data included in the record corresponding to the transaction indicated by the tab image G11.

When the CPU 41 detects depression of the total key via the signal input unit 45 after changing the sales data, the CPU 41 calculates, on the basis of commodity unit prices and the numbers of sold items concerning commodities included in the changed sales data, a total amount of the commodities. The CPU 41 generates update data including the calculated total amount, a transaction number of the transaction (the record) as the target of change, and the changed sales data. The CPU 41 transmits the update data to the settlement terminal 3 to update the sales data and the total amount included in the record corresponding to the transaction number of the transaction as the target of change.

On the other hand, the settlement terminal 3 includes, as shown in FIG. 2, a CPU 51 configured to perform various kinds of arithmetic processing, a ROM 52 configured to store various control programs executed by the CPU 51, a RAM 53 configured to function as a work area of the CPU 51, a signal input unit 54 configured to capture a signal from the keyboard 32, a display control unit 55 configured to output display data to the display device 33 and the display device 34, a printer control unit 56 configured to output print data to the printer 35, and a communication unit 57 connected to the registration terminal 2 via the transmission line N.

The RAM 53 includes the settlement table 531 for registering and managing sets of transaction numbers, sales data, and total amounts transmitted from the registration terminal 2. FIG. 5 is a diagram of an example of data items included in the settlement table 531. As shown in the figure, the settlement table 531 includes data items such as a “transaction number” in which a transaction number is stored, “sales data” in which sales data (a commodity code, a commodity name, a commodity unit price, and the number of sold items) is stored, and a “total amount” in which a total amount of sold commodities is stored.

The CPU 51 sequentially stores, every time the CUP 51 receives a set of a transaction number, sales data, and a total amount from the registration terminal 2 via the communication unit 57, the set of the transaction number, the sales data, and the total amount in the settlement table 531 as a record related to a settlement target transaction. In other words, a record related to a transaction being settled or not settled is stored in the settlement table 531. In this embodiment, as shown in FIG. 5, it is assumed that areas (#01 to #03) that can store records for three transactions are secured in the settlement table 531 and the records are sequentially stored in order from the area (#01) at the top included in the settlement table 531.

When the CPU 51 reads out a record from the settlement table 531, the CPU 51 causes the display device 33 to display the record as a settlement screen via the display control unit 55. The casher checks the settlement screen and performs settlement for the customer who finishes registration in the registration terminal 2.

FIG. 6 is a diagram of an example of the settlement screen displayed on the display device 33. In the figure, a display area G21 is a display area in which transaction content being currently settled is displayed. Record content stored in the area at the top (#01 in FIG. 5) of the settlement table 531 is displayed in the display area G21. A display area G22 is a display area in which settlement-waiting transaction content to be settled next is displayed. Record content stored in the second area from the top (#02 in FIG. 5) of the settlement table 531 is displayed in the display area G22. The display area G23 is a display area in which settlement-waiting transaction content to be settled after next is displayed. Record content stored in the third area from the top (#03 in FIG. 5) of the settlement table 531 is displayed in the display area G23. In other words, settlement order of settlement of transactions and contents of records related to the transactions are displayed on the settlement screen in association with each other. The CPU 51 switches, according to update of the settlement table 531, contents displayed in the display areas G21 to G23.

The casher who operates the settlement terminal 3 checks transaction content being currently settled referring to the display area G21 and asks the customer to pay a total amount displayed on the display screen. The casher receives the amount paid by the customer, inputs a numerical value corresponding to the amount with the numeric keys, and then depresses the cash total key. In the example shown in FIG. 6, an amount (a deposit amount) input by the numeric keys is displayed in the display area G21.

When the CPU 51 detects the depression of the cash total key via the signal input unit 54, the CPU 51 subtracts the total amount from the amount input by the numeric keys to calculate a change amount and causes the display device 33 to display a result of the calculation in the display area G21. In the example shown in FIG. 6, 10 yen obtained by subtracting a total amount 1990 yen from a deposit amount 2000 yen is displayed as a change amount. The CPU 51 controls the printer control unit 56 to cause the printer 35 to output transaction contents of the settled transaction (the transaction number, the commodity code, the commodity name, the number of sold items, the total amount, the deposit amount, the change amount, etc.).

Consequently, the settlement processing for one transaction ends. According to the end of the settlement processing, the CPU 51 stores the record concerning the settlement target transaction, i.e., the record stored in the area #01 of the settlement table 531 in another storage device (not shown) such as a HDD or outputs the record to a host server apparatus (not shown) to record the record as an actual sales result. Further, the CPU 51 deletes the record stored in the area #01 of the settlement table 531. Consequently, the records stored in the second area from the top (#02) and the third area from the top (#03) of the settlement table 531 are respectively moved to areas immediately above the areas and the settlement screen of the display device 33 is updated.

When the CPU 51 receives a readout request from the registration terminal 2, the CPU 51 sequentially reads out the records (the transaction numbers, the sales data, and the total amounts) stored in the settlement table 531 in order from the top area included in the settlement table 531 and transmits the records to the registration terminal 2.

Further, when the CPU 51 receives update data transmitted from the registration terminal 2, the CPU 51 checks in which area of the settlement table 531 a record corresponding to a transaction number included in the update data is stored to determine whether the update target record relates to a transaction being currently settled. If the update target record is stored in an area other than the top area, the CPU 51 determines that a transaction related to the record is in a state of wait for settlement and changes the storage area of the record to an area immediately under the storage area to lower the settlement order of the transaction by one. The CPU 51 updates, on the basis of sales data and a total amount included in the update data, sales data and a total amount of the record corresponding to the transaction number included in the update data. If the update target record is stored in the top area, the CPU 51 determines that a transaction related to the record is being currently settled and updates (changes) the relevant record on the basis of the update data.

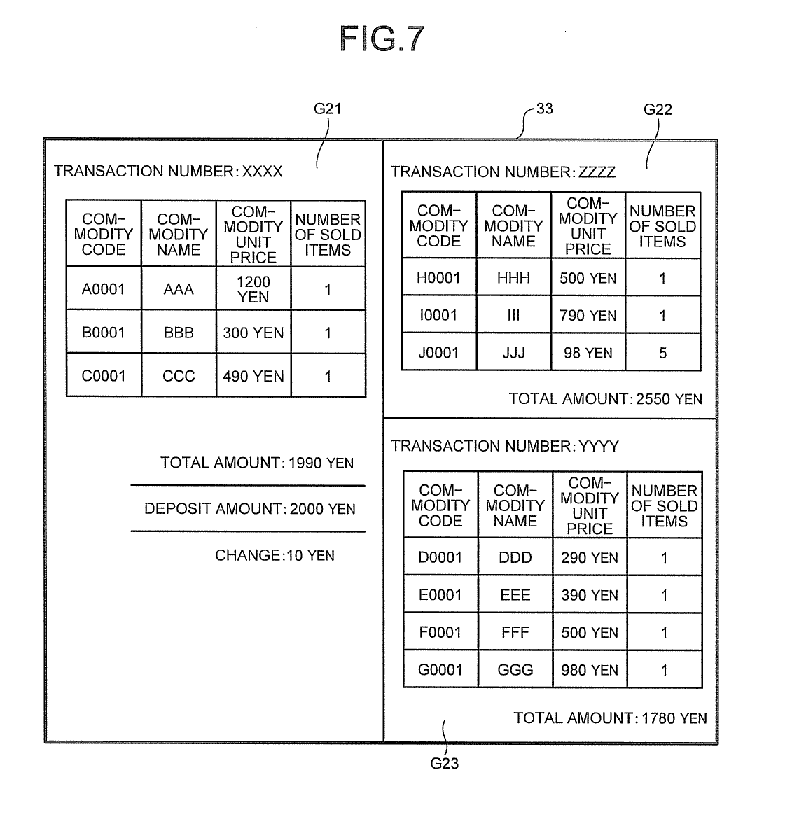

For example, when the record stored in the second area from the top of the settlement table 531 is an update target, the CPU 51 replaces the record stored in the second area from the top with the record stored in the third area from the top to lower settlement order of the update target record by one. According to this record operation, display contents of the areas G22 and G23 in FIG. 6 are changed as shown in FIG. 7. An example shown in FIG. 7 indicates a result obtained when the number of sold items of a commodity name EEE is changed from “2” to “1” in sales data of a transaction number YYYY shown in FIG. 6. When an update target record is stored in the bottom area (e.g., #03 in FIG. 5), update of the record is performed without settlement order of the record being lowered.

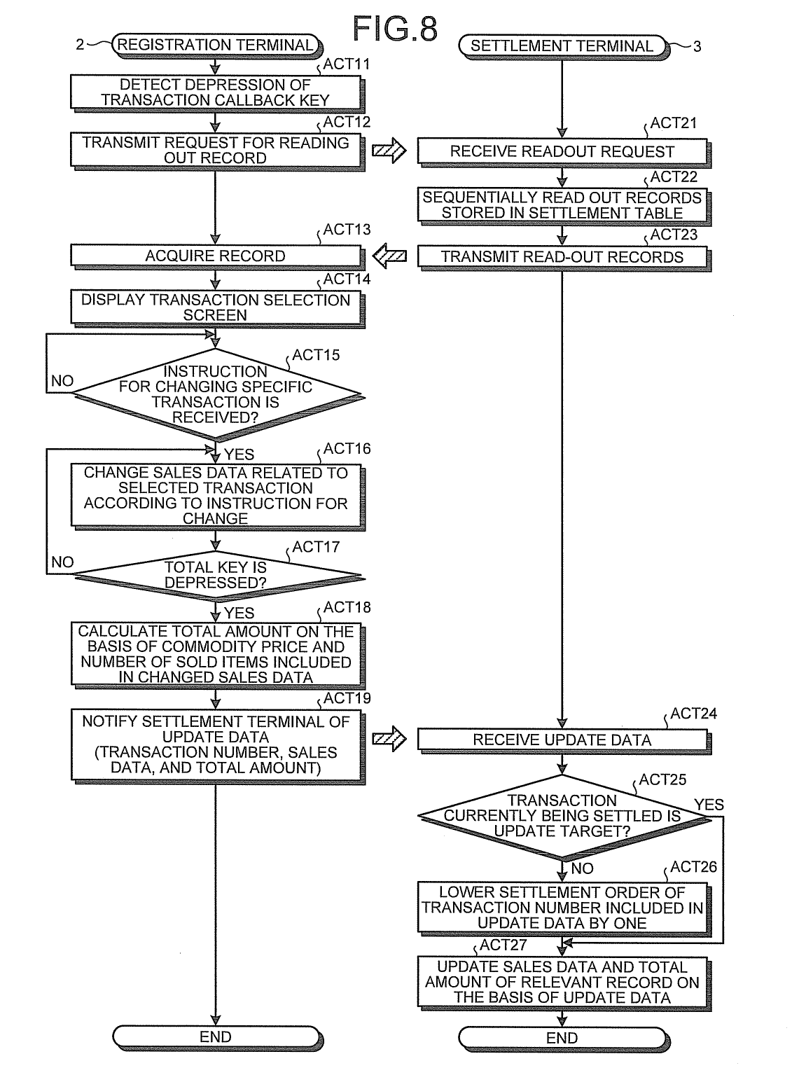

Sales data changing processing executed in the commodity sales processing apparatus 1 is explained below with reference to FIG. 8. Acts 11 to 19 of the processing are acts executed by cooperation of the CPU 41 of the registration terminal 2 and the control program stored in the ROM 42. Acts 21 to 27 are acts executed by cooperation of the CPU 51 of the settlement terminal 3 and the control program stored in the ROM 52.

First, in the registration terminal 2, when the CPU 41 detects depression of the transaction callback key via the signal input unit 45 (Act 11), the CPU 41 transmits a record readout request to the settlement terminal 3 (Act 12).

On the other hand, in the settlement terminal 3, when the CPU 51 receives a readout request (Act 21), the CPU 51 sequentially reads out the records stored in the settlement table 531 in order from the top area (Act 22) and transmits the records to the registration terminal 2 via the communication unit 57 (Act 23).

In the registration terminal 2, when the CPU 41 acquires a record from the settlement terminal 3 (Act 13), the CPU 41 causes the display device 22 to display the transaction selection screen shown in FIG. 4 on the basis of various kinds of information included in the record (Act 14). The CPU 41 stays on standby until a change of transaction content is instructed for a specific transaction (record) selected on the transaction selection screen (No in Act 15).

If the CPU 41 receives an instruction for changing the specific transaction (record) (Yes in Act 15), the CPU 41 changes sales data included in the record according to the instruction for change (Act 16).

Subsequently, the CPU 41 executes Act 16 until the CPU 41 detects depression of the total key (No in Act 17). If the CPU 41 detects depression of the total key via the signal input unit 45 (Yes in Act 17), the CPU 41 calculates, on the basis of unit prices and the numbers of sold items concerning commodities included in the changed sales data, a total amount of the commodities (Act 18). The CPU 41 generates update data including the calculated total amount, a transaction number of the transaction (the record) as the target of change, and the changed sales data and transmits the update data to the settlement terminal 3 (Act 19).

On the other hand, in the settlement terminal 3, when the CPU 51 receives the update data (Act 24), the CPU 51 checks, referring to the settlement table 531, whether a record corresponding to the transaction number included in the update data is stored in the top area to determine whether the update target record is a record related to the transaction currently being settled (Act 25). If the record is stored in the top area, the CPU 51 determines that a transaction related to the update target record is currently being settled (Yes in Act 25), updates sales data and a total amount included in the record to the sales data and the total amount included in the update data (Act 27), and ends the processing.

In Act 25, if the update target record is stored in an area other than the top area, the CPU 51 determines that the transaction related to the update target record is in a state of wait for settlement (No in Act 25). In this case, the CPU 51 changes the storage area of the update target record to an area immediately under the storage area to lower settlement order of the transaction by one (Act 26). The CPU 51 updates the sales data and the total amount included in the update target record to the sales data and the total amount included in the update data (Act 27), and ends the processing.

As explained above, with the commodity sales processing apparatus 1 according to this embodiment, sales data related to a transaction being settled or waiting for a settlement registered in the settlement terminal 3 can be changed at arbitrary timing from the registration terminal 2. Therefore, it is possible to efficiently process a change of the sales data. If sales data related to a settlement-waiting transaction is a target of change, it is possible to smoothly process the transaction by lowering settlement order of the transaction by one.

The embodiment is explained above. However, the present invention is not limited to this. Various changes, substitutions, additions, and the like are possible without departing from the spirit of the present invention.

For example, in the embodiment, if sales data related to a settlement-waiting transaction is a target of change, settlement order of the transaction is lowered by one. However, the present invention is not limited to this. The sales data may be changed while the previous settlement order is maintained. Specifically, it is possible to realize this form by skipping the determination in Act 25 in FIG. 8.

In the embodiment, a transaction number is given in the registration terminal 2. However, the present invention is not limited to this. The transaction number may be given on the settlement terminal 3 side when sales data and a total amount are registered.

In the embodiment, the registration terminal 2 selects an update target transaction (record) after acquiring all the records registered in the settlement terminal 3. However, the present invention is not limited to this. The registration terminal 2 may acquire, after an update target transaction is selected, only a record corresponding to the update target transaction from the settlement terminal 3.

Computer programs executed by the CPU 41 and the CPU 51 according to the embodiment are provided while being incorporated in a ROM or the like in advance. However, the present invention is not limited to this form. For example, the computer programs may be provided while being recorded in a computer-readable recording medium such as a CD-ROM, a flexible disk (FD), a CD-R, or a DVD as a file of an installable format or an executable format. The computer programs may be stored on a computer connected to a network such as the Internet and provided by being downloaded through the network. The computer program may be provided or distributed through the network such as the Internet.

What is claimed is:

1. A registration terminal comprising:
a connecting unit connected to a settlement terminal, the settlement terminal being configured to store sales data indicating transaction content of a transaction for purchase of a commodity transmitted from an outside and execute processing concerning settlement of the transaction on the basis of the stored sales data;
a generating unit configured to generate, every time the transaction is performed, sales data indicating content of the transaction;
a registering unit configured to transmit the sales data generated by the generating unit to the settlement terminal;
a readout requesting unit configured to request the settlement terminal to read out the sales data stored in the settlement terminal; and
a changing unit configured to change the transaction content of the sales data readout from the settlement terminal and transmit the sales data after the change to the settlement terminal as sales data for update.

2. The apparatus according to claim 1, further comprising a calculating unit configured to calculate a total amount of commodities related to one transaction on the basis of unit prices and numbers of sold items indicated by the transaction content of the sales data, wherein
the registering unit transmits the total amount calculated by the calculating unit to the settlement terminal together with the sales data, and
the changing unit transmits a new total amount calculated by the calculating unit on the basis of the transaction content after the change to the settlement terminal as a total amount for update together with the sales data for update.

3. The apparatus according to claim 1, further comprising a receiving unit configured to receive an instruction for changing specific sales data as a target of change among the sales data read out from the settlement terminal, wherein
the changing unit changes transaction content of the specific sales data on the basis of the instruction for change received by the receiving unit.

4. A transaction content changing method executed in a registration terminal connected to a settlement terminal, the settlement terminal being configured to store sales data indicating transaction content of a transaction for purchase of a commodity transmitted from an outside and execute processing concerning settlement of the transaction on the basis of the stored sales data, the transaction content changing method comprising:
allowing a generating unit to generate, every time the transaction is performed, sales data indicating content of the transaction;
allowing a registering unit to transmit the sales data generated by the generating unit to the settlement terminal;
allowing a readout requesting unit to request the settlement terminal to read out the sales data stored in the settlement terminal; and
allowing a changing unit to change the transaction content of the sales data read out from the settlement terminal and transmit the sales data after the change to the settlement terminal as sales data for update.

5. A settlement terminal comprising:
a connecting unit connected to a registration terminal configured to generate, every time a transaction for purchase of a commodity is performed, sales data indicating content of the transaction;
a storing unit configured to store the sales data transmitted from the registration terminal;
a readout unit configured to read out, according to a readout request from the registration terminal, the sales data stored in the storing unit and transmit the sales data to the registration terminal; and
an updating unit configured to update, on the basis of sales data for update, in which the transaction content is changed, transmitted from the registration terminal, the sales data stored in the storing unit corresponding to the sales data for update.

6. The apparatus according claim 5, further comprising a settling unit configured to sequentially perform settlement of the transaction in order of the sales data stored in the storing unit.

7. The apparatus according to claim 6, wherein the updating unit changes, according to whether update target sales data corresponding to the sales data for update is being settled by the settling unit, order for settlement of the update target sales data.

8. The apparatus according to claim 5, wherein
the storing unit stores, in association with the sales data, a total amount transmitted together with the sales data from the registration terminal, and
the changing unit updates, when a total amount for update is received from the registration terminal together with the sales data for update, a total amount associated with update target sales data to the total amount for update.

9. A transaction content changing method executed in a settlement terminal connected to a registration terminal configured to generate, every time a transaction for purchase of a commodity is performed, sales data indicating content of the transaction, the transaction content changing method comprising:
allowing a storage control unit to store the sales data transmitted from the registration terminal in a storing unit;
allowing a readout unit to read out, according to a readout request from the registration terminal, the sales data stored in the storing unit and transmit the sales data to the registration terminal; and
allowing an updating unit to update, on the basis of sales data for update, in which the transaction content is changed, transmitted from the registration terminal, the sales data stored in the storing unit corresponding to the sales data for update.

10. A two-person type commodity sales processing apparatus comprising a registration terminal and a settlement terminal, wherein
the registration terminal includes:
a generating unit configured to generate, every time a transaction for purchase of a commodity is performed, sales data indicating content of the transaction;
a registering unit configured to transmit the sales data generated by the generating unit to the settlement terminal;
a readout requesting unit configured to request the settlement terminal to read out the sales data stored in the settlement terminal; and
a changing unit configured to change the transaction content of the sales data read out from the settlement terminal and transmit the sales data after the change to the settlement terminal as sales data for update, and
the settlement terminal includes:
a storing unit configured to store the sales data transmitted from the registration terminal;
a readout unit configured to read out, according to a readout request from the registration terminal, the sales data stored in the storing unit and transmit the sales data to the registration terminal; and
an updating unit configured to update, on the basis of the sales data for update transmitted from the registration terminal, the sales data stored in the storing unit corresponding to the sales data for update.
